(19) United States
(12) Patent Application Publication
(10) Pub. No.: US 2024/0066951 A1
(43) Pub. Date: Feb. 29, 2024

(54) THERMAL SYSTEM FOR A VEHICLE

(71) Applicant: Tesla, Inc., Austin, TX (US)

(72) Inventors: Brendan Kawar, San Jose, CA (US); Simon Colliss, Redwood City, CA (US)

(21) Appl. No.: 18/270,462

(22) PCT Filed: Jan. 27, 2022
(86) PCT No.: PCT/US2022/014102

§ 371 Date: Jun. 29, 2023

Related U.S. Application Data
(60) Provisional application No. 63/142,992, filed on Jan. 28, 2021.

(51) Int. Cl. B60H 1/00

(52) U.S. Cl. CPC B60H 1/00871

(57) ABSTRACT

A thermal system for a vehicle, including a first vent (202) and a second vent (206) connected to at least one air source corresponding to an HVAC unit, wherein each vent (202, 206) receives air from the at least one air source to produce a plane of air, the first and second vents (202, 206) are configured to respectively redirect a first plane of air and a second plane of air to intersect on or along a portion of a blending surface (204) to form a combined air jet which can be directed into a cabin of the vehicle and the 208 blending surface can be a flat, convex, or concave display or instrument panel.

### CROSS-REFERENCE TO RELATED APPLICATION

This application claims the benefit of U.S. Provisional Application No. 63/142,992, entitled “THERMAL SYSTEM”, and filed on Jan. 28, 2021. U.S. Provisional Application No. 63/142,992 is incorporated by reference herein.

### BACKGROUND

### Technical Field

Embodiments of this disclosure relate to thermal, air supply, and HVAC systems, for example, in vehicles.

### Description of Related Art

Air supply for the benefit of a person is used in a variety of contexts. One such area is the passenger compartment of a vehicle, where air is typically introduced through one or more vents. For example, such vents can be positioned in the instrument panel for use primarily by the front seat occupants, and sometimes also in a second (or higher) row of seats for other passengers as well. The vents are usually controlled to regulate the flow of air entering the cabin, and the direction thereof. The vents are connected to the vehicle's heating, ventilation and air conditioning (HVAC) system so that hotter, colder and/or dehumidified air can be supplied as desired.

### BRIEF DESCRIPTION OF THE DRAWINGS

Various features will now be described with reference to the following drawings. Throughout the drawings, reference numbers may be re-used to indicate correspondence between referenced elements. The drawings are provided to illustrate examples described herein and are not intended to limit the scope of the disclosure.

FIG. 1 depict an illustrative thermal system according to one or more aspects of the present application;

FIGS. 2A, 2B, and 2C depict illustrative vents and blending surfaces of the thermal system according to one or more aspects of the present application;

FIGS. 3A, 3B, and 3C depict illustrative blending of air jets from vents along a portion of a blending surface of the thermal system according to one or more aspects of the present application;

FIG. 4 depicts illustrative vanes and controls of the thermal system according to one or more aspects of the present application;

FIG. 5 depicts a flowchart of the operation of the thermal system according to one or more aspects of the present application;

FIG. 6 depicts illustrative vents and a blending surface of the thermal system in the dash of a vehicle according to one or more aspects of the present application;

FIG. 7 depicts an illustrative thermal system according to one or more aspects of the present application.

### DETAILED DESCRIPTION OF EMBODIMENTS

The following description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

Some air supply systems allow reduced visibility vent outlets by transitioning to a thin slot outlet with aerodynamical positioning of the air jets to reduce visible vanes and flaps. These aerodynamic designs have fundamental control and stability limitations. For example, there must be a minimization of the height of the outlet slot. Additionally, the vent design may require control of a certain areas around the outlets which would limit on the proximity of the outlets to other objects (for example displays) that are not aerodynamic part of the air supply system.

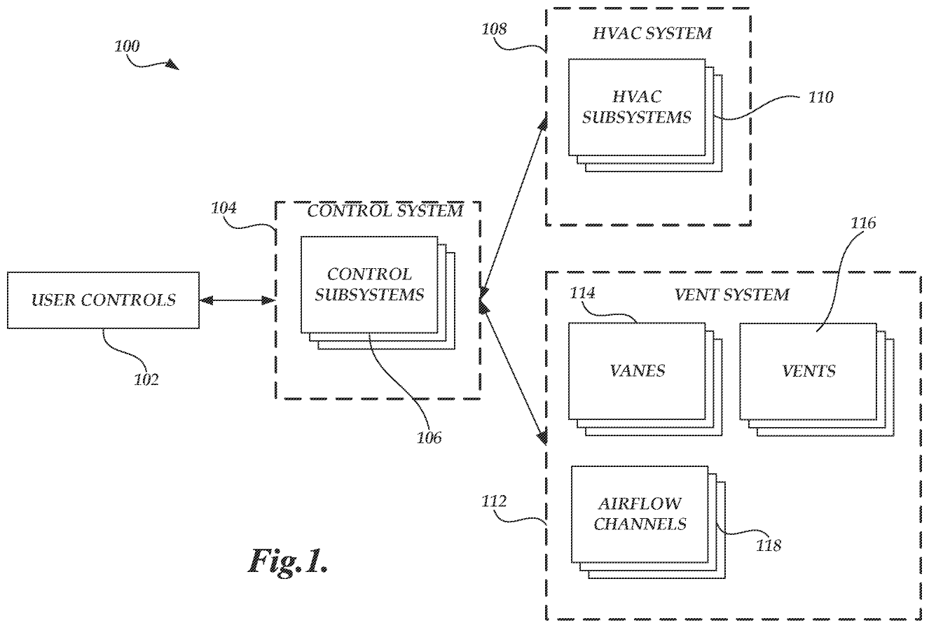

One or more aspects of the present application relate to an air supply or thermal system for vehicles. FIG. 1 illustrates an example air supply or thermal system 100 for a vehicle (not illustrated). The thermal system 100 can illustratively be composed of an HVAC system 108, a vent system 112, and a control system 104. A user can control the thermal system 100 through the user of user controls 102. The control system 104 can then use these user indications to determine how to control the HVAC system 108 and the vent system 112.

The user controls 102 are designed to give the user control over many aspects of the air supply and thermal system for the vehicle. For example, the user controls 102 can be used to control temperature, humidity, the direction and speed of air coming out of the vents, whether the air is being cycled throughout the vehicle, and which vents are being used. The user controls 102 can also be used to control the above factors in various parts of the vehicle such that different occupants can experience different environmental settings. For example, a user may control the driver side vents to have a higher speed of air coming out of the driver side vents than the vents for the front seat passenger. As a further example, the user may control the driver side vents to have more air conditioning than the vents for the front seat passenger. Similarly, the vents for windows and mirrors can be adjusted separately from vents meant for the passengers and driver. User controls 102 can be any kind of vehicle user controls such as buttons, dials, the use of a capacitive touch screen, or any other typical way in which a user can interact with a device, computer, or interactive control schema.

User controls 102 can also include the option to direct the vents at the head of an occupant (for example, the driver), a seat position, the ceiling, or the floor. If the user directs the vents at the head of an occupant, the control system 104 can use an internal camera of the vehicle to detect the location of the head of the occupant. Alternatively, the user may want to direct the vents away from the head of an occupant.

The control system 104 receives input from the user controls 102. The control system 104 is composed of one or more control subsystems 106. These control subsystems 106 are used to determine how to change the user input into the desired outcome of the thermal system. The control system 104 can include a controller, a processor, memory, and storage. The control system 104 sends instructions to the HVAC system 108 and the vent system 112. Likewise, the control system 104 can receive feedback and/or updates from the HVAC system 108 and the vent system 112, which may include sensors to detect conditions in their respective systems. Similarly, the control system 104 can send feedback to the user controls to show updates in the HVAC system 108 and the vent system 112. For example, the control system 104 can indicate to the user controls 102 that fan speed has increased or air conditioning has been increased.

The HVAC system 108 controls heating, ventilation, and conditioning. The HVAC system 108 is comprised of one or more HVAC subsystems 110 which function as sources of air jets for purposes of providing heating, air conditioning, and ventilation air streams to an interior compartment of a vehicle. HVAC systems for vehicles are well known. The HVAC system 108 can include sensors to detect conditions related to the HVAC system 108 and the HVAC subsystems 110. The HVAC subsystems 110 can include individual HVAC subsystems that can provide individual air streams for portions of the vehicle compartment, such as a first HVAC subsystem 110 that provides air streams directed to an area of the interior compartment associated with a vehicle driver (or driving position) and a second HVAC, subsystem 110 that provides air streams directed to an areas of the interior compartment associated with a front passenger different from the vehicle driver (or driving position). The individual HVAC subsystems 110 may be independently operable in some embodiments. In other embodiments, the HVAC, subsystems 110 may be configured in a synchronized manner or partially synchronized manner as described herein.

The vent system 112 controls how air from the HVAC system is directed into the cabin of the vehicle. The vent system 112 includes one or more vanes 114, one or more vents 116, and one or more airflow channels 118. The vent system can also include other vent subsystems. Airflow channels 118 are the conduits through which air flows from the HVAC system 108 and the HVAC subsystems 110 into the vents 116. The vents 116 receive air from the airflow channels 118. Outlets of the vents 116 are where air from the vent system 112 enter the cabin of the vehicle. Vanes 114 are used to direct air through the airflow channels 118 and/or the vents 116. Vanes can be located in the airflow channels 118 or in the vents 116. Vanes 114 can be actuated manually, mechanically, or electrically.

Illustratively, the thermal system 100 includes a first vent 116 and a second vent 116 connected to at least one air source corresponding to an HVAC unit 108. Each vent 116 receives air from the at least one air source to independently produce a plane of air. The first vent 116 and second vent 116 are configured to respectively redirect a first plane of air and a second plane of air to intersect on or along a portion of a blending surface in the vehicle compartment to form a combined air jet. The combined air jet can be directed into the compartment (e.g., cabin) of a vehicle. Illustratively, the first plane of air and the second plane of air do not correspond to substantially horizontal plane that would allow the respective plane of air to be directed into the vehicle compartment. Rather, the first plane of air and second plane of air are directed to opposing angles, relative to a horizontal plane, that causes the generation of the combined air jet that is directed to the interior vehicle compartment (e.g., vehicle cabin). The direction and angle of the combined air jet can be dynamically adjustment responsive to inputs or identified location attributes. The blending surface can illustratively be a flat, convex, or concave surface. Additionally, the blending surface can further have additional functionality, such as forming a portion of a display or instrument panel associated with the vehicle. The outlets of the first vent 116 and the second vent 116 can be hidden from typical sightlines of occupants of a vehicle.

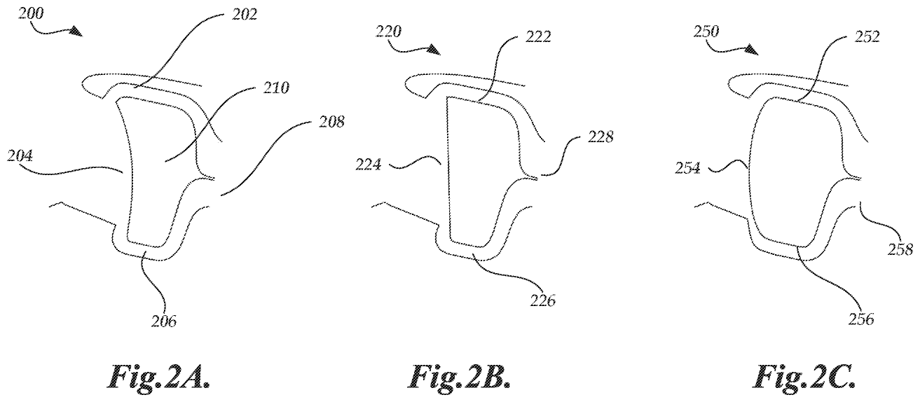

FIGS. 2A, 2B, and 2C illustrate vent structures which are portions of the vent system 112. More specifically, FIGS. 2A-2C illustrative various embodiments of vent structures 200, 220, 250 in which the blending surface has surface structure (e.g., concave, flat and convex). FIGS. 2A-2C represent illustrative examples of types of surface structure, however, and should not be construed as limited to any particular angular of curvature, dimension or shape. FIG. 2A illustrates an example vent structure 200. Air is received from the HVAC system 108 into the airflow channel 208. The airflow channel 208 then directs air into a first inlet of a first vent 202 forming a first air jet and a second inlet of a second vent 206 forming a second air jet. The first vent 202 has a first outlet which produces a first plane of air from the first air jet at an acute angle to a first horizontal plane. The first plane of air from the first outlet is directed into the cabin. The second vent 206 has a second outlet produces a second plane of air from the second air jet, which directs the second plane of air at an obtuse angle relative a second horizontal plane. The first horizontal plane can be a parallel plane to the second horizontal plane, wherein the first horizontal plane above the second horizontal plane. In this way, the first vent 202 can be considered a top vent and the second vent 206 can be considered a bottom vent. In some configurations, the first plane of air can be directed at an obtuse angle relative to the blending surface. In some configurations, the second plane of air can be directed at an acute angle relative to the blending surface.

The second plane of air from the second outlet and the first plane of air from the first outlet intersect along a portion of the blending surface 204. The first outlet and the second outlet are configured to cause this intersection of the first plane of air and the second plane of air. When the first plane of air and the second plane of air intersect, the momentums of the first plane of air and the second plane of air create a combined air jet directed into the cabin of the vehicle.

The respective speeds (and therefore momentums) of the first plane of air and the second plane of air to each other determines the angle of the combined air jet into the cabin. A lower speed second plane of air will lead to a lower angle into the cabin of the vehicle while a higher speed second plane of air will lead to a higher angle into the cabin of the vehicle. Alternatively, a higher speed first plane of air will lead to a lower angle in the cabin of the vehicle while a lower speed first plane of air will lead to a higher angle into the cabin of the vehicle.

The vent outlets can have a height of 15 mm, 20 mm, 40 mm, 80 mm or any height between 10 mm and 200 mm depending on where the vent is located. The vent outlets can have a width corresponding to the width of the surface or module around which the vents are placed.

The vent structure 200 also allows for the simple installation and/or maintenance of the vent and any surface or electrical or other nearby equipment. The vent structure is configured such that the vent kinematics and actuation can be combined with any electronics (for example a display) to localize electromechanical complexity to an install module 210. This makes it significantly simpler to install and maintain both the vent structure 200 and any electronic equipment around which the vent is structured. One of the advantages of this vent structure 200 is that it can be combined with other electrical and mechanical elements when space is at a premium.

FIG. 2A further illustrates an example vent structure 200 wherein the blending surface 204 is a concave surface. The length of the concavity of the blending surface or a portion of the blending surface can be any of a number of values including, but not limited to, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, or 20 mm. FIG. 2B illustrates an example vent structure 220 wherein the blending surface 224 is a flat surface (or substantially flat). FIG. 2B illustratively includes similar first vent 222, second vent 226 and airflow channel 228 as described with regard to FIG. 2A. The first vent 222 can be considered a top vent and the second vent 226 can be considered a bottom vent. FIG. 2C illustrates an example vent structure 250 wherein the blending surface 254 is a convex surface. The length of the convexity of the blending surface or a portion of the blending surface can be any of a number of values including, but not limited to, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, or 20 mm. Similarly, FIG. 2C illustratively includes similar first vent 252, second vent 256 and airflow channel 258 as described with regard to FIG. 2A. The first vent 252 can be considered a top vent and the second vent 256 can be considered a bottom vent

The outlets of vents can also be referred to as slots. The use of two vents and a blending surface allows slot height limitations to be minimized allowing for more variation in slot height. This system also allows the slots to be angled away or covered from typical sightlines of vehicle occupants, reducing apparent size of the slots to occupants by a significant margin. This system is also more flexible for overall vent system size, allowing vents and outlets to be incorporated into other parts of a vehicle including door handles, arm rests, seats, and the backs of seats for ventilation for different occupants of the vehicle. Additionally, the vent structure is designed such that it can incorporate other objects or be close to other objects in the vehicle. For example, the blending surface could be a display. Furthermore, covers can be placed over, around, or near the slots in order to minimize the apparent size of the slot when viewed from typical occupant sightlines.

Aspects of the present application correspond to an air supply system that enables the integration of the vent outlets with other potentially larger scale outward facing surface objects (for example a display) in a way that reduces vent visibility and increases component integration, without compromising the vent functionality. Vent visibility is reduced by placing vent outlets at an extreme angle to the typical sightlines, thereby reducing their apparent size.

Furthermore, the present application allows for preserving surface space, which is oftentimes at a premium. Oftentimes space on a front dash or on a second-row console is limited. The control of airflow through the vents can he split between the first vent and the second vent locally or remotely to save space behind the vents. For example, the vanes can be in the vents or the airflow channels. Alternatively, the vanes can he close to the HVAC system and away from the localized area of the vents. This gives flexibility in installation of the vent structure without compromising the goal of reducing outlet visibility and integration. The choice of whether to place the mechanical functionality at the vent outlet itself or within a centralized unit gives maximum flexibility to the uses of the vent structure and overall thermal system.

Illustratively, the spacing between outlets of corresponding vents is highly flexible. Thus, the vent topology could be formed in a similar-sized package on a user facing surface as a traditional vent, but retain the same benefits of reduced visibility and allow for remote or local system control of airflow.

The streamwise length of the vents 202, 206 and/or the airflow channels 208 is also flexible allowing a compact side packaging that would allow vent placement in non-traditional places such as seat backs without compromising jet direction range or uniformity.

Due to the inherently high jet direction angle range, the system also does not need to be perpendicular to the occupant's line of sight, allowing vent placement on more angled surfaces for improved design freedom.

Additionally, in future autonomous vehicles where passenger seating positions and directions are not rigidly defined, the ability of this vent structure to integrate closely with displays could provide an advantage. This vent structure could be incorporated into an occupant-facing object to provide non-ambient cabin ventilation, where reduced line of sight to the outlet could be desirable.

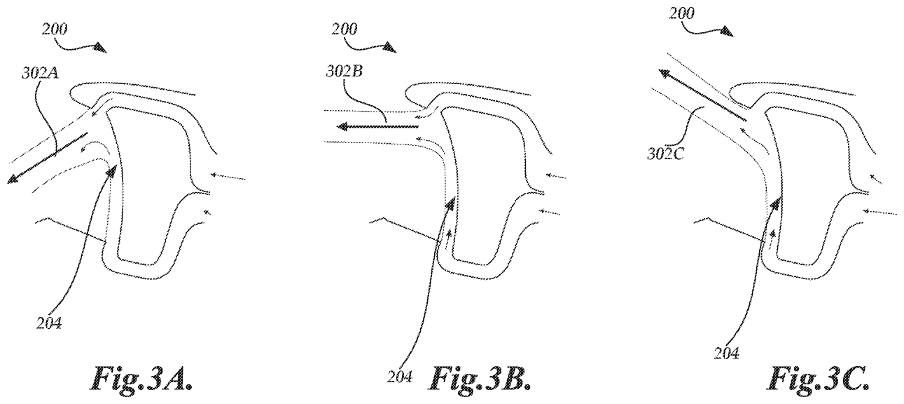

FIGS. 3A, 3B, and 3C illustrate how the planes of air from the first vent and the second vent intersect along a portion of the blending surface to form the combined air jet directed into the cabin of the vehicle at different directions. Illustratively, FIGS. 3A-3C illustrate the blending process with regard to vent structure 200. However, the general principles of the direction of a combined air jet would also be applicable with regard to any of the other vent structures disclosed or variations thereof. The jet direction of the combined jet may be required to point along sightlines to reach a target location, such as general areas of the interior compartment or specific areas on individuals in the interior compartment (e.g., an occupant's face, torso, arms. etc.), In accordance with aspects of the present application, the jet direction of the combined air jet 302 can be directed in a manner to point along sightlines. This can further be achieved with without traditional vents or outlets being integrated into the vehicle dash, which makes the traditional vents or outlets visible to the occupants along sightlines. More specifically, illustratively the combined air jet can be recovered aerodynamically through blending the momentum of multiple planes of air, while using the included blending surface 204 to provide support to the jet/plane interaction through building up locally higher air pressure.

The position of the combined air jet 302 may then be controlled by adjusting the proportion of the total air flow being fed or directed to the first outlet and the second outlet. Controlling and adjusting the proportion of the total air flow being fed to each out may be done manually, mechanically, or electronically. FIGS. 3A-3B illustrated different resulting directions for the respective combined air jet 302A, 302B, and 302C based on variations of the input parameters from the source planes of air generated by the top vent 202 and bottom vent 206 (FIG. 2A).

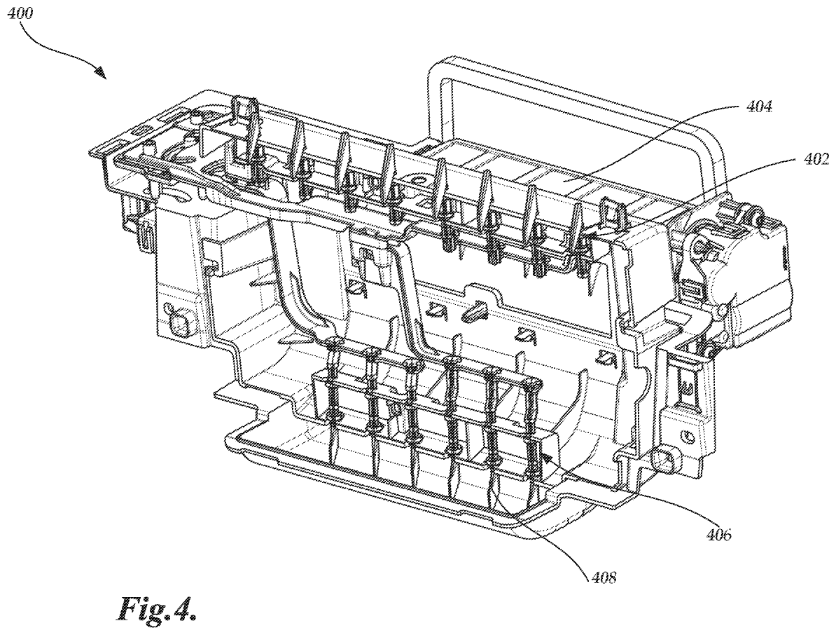

FIG. 4 illustrates an example set of vanes 114 of the vent system 112 for the thermal system 100. The vanes 114 help direct the air while in the air channels 118 or in the vents 116. As such, the vanes 114 can be located either in the air channels 118 or the vents 116. Alternatively, the vanes can be located closer to a central airflow channel or HVAC system, remote from the vents. There are multiple types of vanes that can be used in the vent system 112. Vanes 402, 408, and 406 are vertical vanes which are used to direct air laterally from side to side. Vanes 402 show a large set of vanes all controlled by a single actuator. Vanes 406 and 408 show smaller sets of vanes which can be controlled by separate actuators. Vanes 404 are horizontal vanes which direct the air vertically up and down. Vanes 404 can be controlled by a separate actuator from vanes 402, 406, and 408. All the vanes 402, 404, 406, and 408 are controlled by the control system 104 to direct air into the correct vents or outlets of vents and at the correct speeds to control the combined air jet as shown in FIGS. 2A-2C.

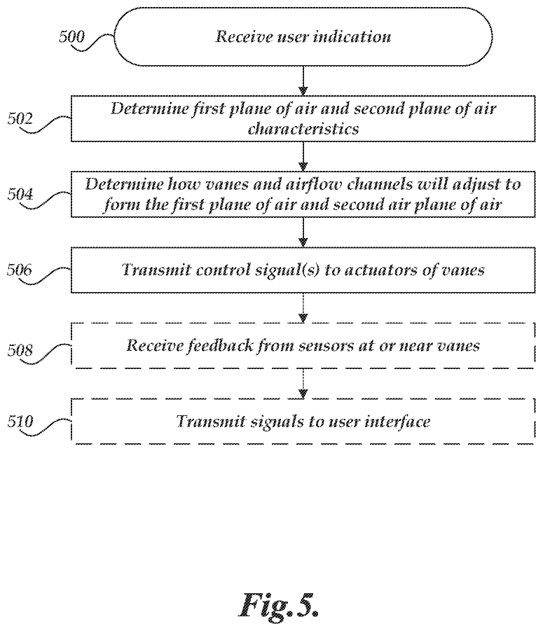

FIG. 5 illustrates an example method that the control system 104 utilizes to control the HVAC system 108 and the vent system 112. In step 500, the control system receives a user indication of a desired direction, location, or profile for the combined air jet into the cabin. The user indication is received by the user controls 102 as described above and then transmitted to the control system 104. The user indication could be a direction to point the combined air jet into the cabin. Alternatively, the user indication could be a location in the cabin where the user would like the combined air jet into the cabin to be directed. Alternatively, the user indication could be a profile of how the user would like the combined air jet to function. For example, the user may want the combined air jet into the cabin to be on their face or avoid their face. The control system may have access to an internal camera in the vehicle to determine the location of the face of the user for determining how to respond to the user indication. Alternatively, the user may want the combined air jet to be directed at the ceiling or the floor of the cabin. Alternatively, the user may want to reduce or eliminate particular combined air jets from particular vents or increase particular combined air jets from particular vents. For example, the user may want no combined air jets out of vents on the passenger side of the vehicle or to turn on combined air jets on the windows to defog the windows.

In step 502 the control system 104 determines the characteristics of the first plane of air and the second plane of air for each vent structure (for example, vent structure 200 of FIG. 2 comprising at least a first vent 202 and a second vent 206). The control system 104 determines which vent structures receive air flow and which vent structures do not receive air flow. Additionally, the control system 104 determines the proper speed and strength of the first plane of air and the second plane of air for each vent structure. In vent structures that have multiple outlets for a single top or bottom vent, the control system 104 determines the proper speed and strength of the plane of airs coming out of those outlets. The control system determines the characteristics of the plane of airs coming out of the vent outlets for the combined air jet into the cabin. Alternatively, the control system can control the first air jet and the second air jet being directed into the first inlet of the first vent and the second inlet of the second vent, respectively. By respectively controlling the first air jet and the second air jet being directed into the first inlet and the second inlet, the control system 104 is able to control the formation of the first plane of air and the second plane of air.

Illustratively, Equation 1 can define fundamentals of mixing efficiencies for input jets as follows:

$$\begin{matrix}E1 & \\ Let {J}_{k} = \frac{{\dot{m}}_{k}^{2}}{ρ {A}_{k}} , then : & Equation 1\end{matrix}$$

$$Outlet angle :$$

$$ϕ = {tan}^{- 1} \frac{( {J}_{\tilde{z}} sin ( {θ}_{\tilde{z}} ) - {J}_{\tilde{x}} sin ( {θ}_{\tilde{x}} )}{( {J}_{\tilde{z}} cos ( {θ}_{\tilde{z}} ) - {J}_{\tilde{x}} cos ( {θ}_{\tilde{x}} )}$$

$$Outlet velocity :$$

$${u}_{R} = \frac{{ζ}_{θ} \sqrt{{{J}_{\tilde{x}} cos ( {θ}_{\tilde{x}} ) + {J}_{\tilde{z}} cos ( {θ}_{\tilde{z}} ) )}^{2} + {( {J}_{\tilde{z}} sin ( {θ}_{z} ) - {J}_{\tilde{x}} sin ( {θ}_{\tilde{x}} ) )}^{2}}}{{\dot{m}}_{\tilde{x}} + {\dot{m}}_{\tilde{z}}}$$

Illustratively, Equation 2 can define fundamentals of mixing efficiencies for input jets as follows:

ζ_{αθ}(\dot{m}_{\tilde{x}}μ_{\tilde{x}}sin θ−\dot{m}_{\tilde{z}}μ_{\tilde{z}}sin θ)=0

X-momentum reduced by turbulent mixing (angled jets) but supported by pressure reaction:

ζ_{Δθ}(\dot{m}_{\tilde{x}}μ_{\tilde{x}}cos θ+\dot{m}_{\tilde{z}}μ_{\tilde{z}}cos θ)+p̅A₊=(\dot{m}_{\tilde{x}}+\dot{m}_{\tilde{z}})μ_{R}

If angles are equal, momentum flux must also be equal to maintain zero outlet angle. So, can write:

$${u}_{R} = {ζ}_{Δθ} {u}_{x} cos θ + \frac{\overline{p} {A}_{+}}{2 {\dot{m}}_{\tilde{x}}}$$

E2 Equation 2

In step 504, the control system 104 determines how the vanes 114 are oriented and how air is passed through airflow channels 118 to achieve the combined air jet into the cabin. As described above, each vent structure can have their own vanes within the top or bottom vents or air channels, or the vanes can be closer to the HVAC system and used to direct air into the air channels. There are both vertical and horizontal vanes. Vertical vanes are used to direct air laterally side to side while horizontal vanes are used to direct air vertically up and down. Some vent structures may correspond to both vertical and horizontal vanes. Some vent structures may only have vertical vanes. Some vent structures may only have horizontal vanes. Vanes are attached to actuators which orient the vanes. All vanes can be attached to the same actuator or to separate actuators. Vanes can be grouped into sets of vanes which are actuated by the same actuator. In some vane structures, there are multiple sets of vertical vanes and only a single set of horizontal vanes,

In step 506, the control system 104 transmits control signal(s) to the actuators of the vanes. This causes the vanes to orient in the directions determined by the control system 104 to result in the combined air jet into the cabin.

In optional step 508, sensors near or at the vanes can be used to transmit feedback to the control system 104. These sensors can be used to determine if the vanes are at the proper orientation of the control system. These sensors can also be used to determine if the vanes are in the process of moving into the proper orientation. These sensors can also be used to detect the characteristics of the air such as temperature, humidity, and the like.

In optional step 510, the control system 104 transmits signals back to the user interface 102. These signals can include confirmation signals that the user jet has been modified as the user indicated. These signals can include updates to specific information about speed of air jets or planes of air, or characteristics of the air such as temperature, humidity, and the like.

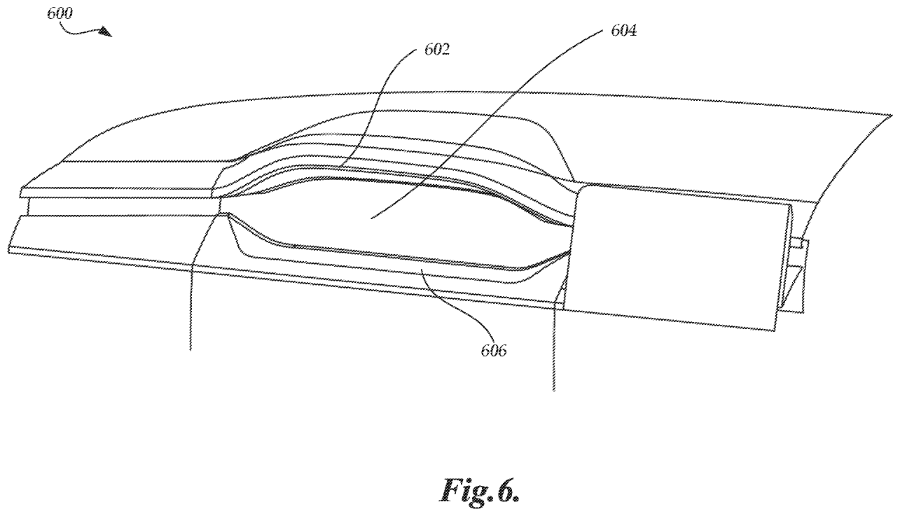

FIG. 6 illustrates an embodiment 600 where the thermal system 100 is incorporated into the dash of a vehicle. The first vent 602 can be incorporated into the dash and positioned above the instrument panel 604. The second vent 606 can be incorporated into the dash and positioned below the instrument panel 604. Both the first vent and the second vent can be hidden from the sightline or view of the driver of the vehicle and/or other passengers by covers. Alternatively, the covers can be used to significantly reduce the apparent size of the vents when viewed along typical sightlines. Both the first vent and the second vent can be covered by their own respective covers. In this example embodiment, the instrument panel 604 acts as the blending surface. As described above, any display or surface over a display could act as a blending surface for vents attached to the thermal system 100. Additionally, the blending surface could be incorporated into other parts of a vehicle including door handles, arm rests, seats, and the backs of seats for ventilation for different occupants of the vehicle.

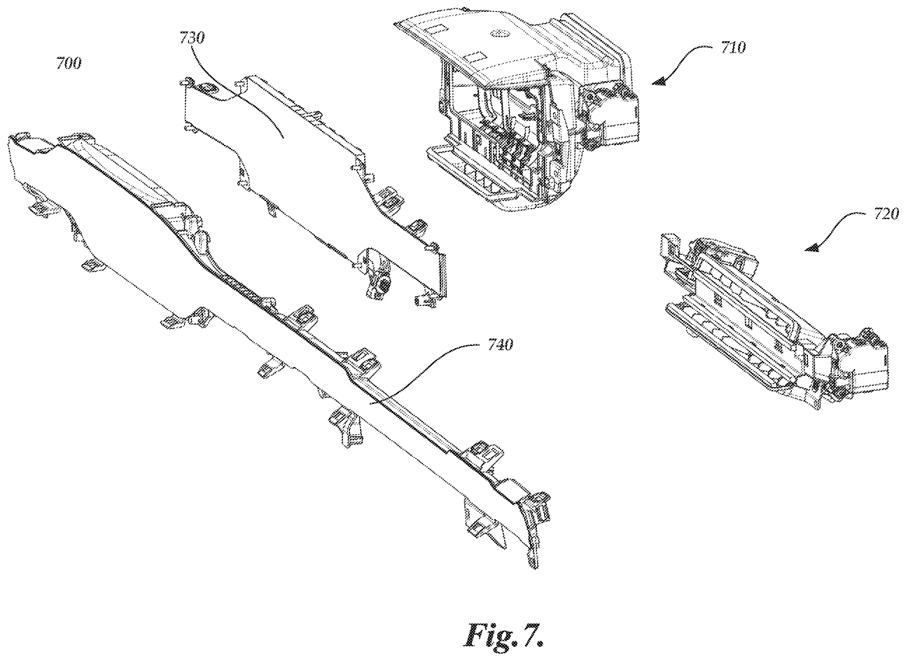

FIG. 7 illustrates an embodiment 700 where the thermal system 100 is incorporated into the front dash of a vehicle. The driver air vent system 710 is configured to be placed behind the instrument cluster 730. The driver air vent system 710 can include vanes and the airway channel from which air from the HVAC system arrives. The driver air vent system 710 is configured to form vents above and below the instrument cluster 730. The passenger air vent system 720 can also include vanes and the airway channel from which air from the HVAC system arrives. Then the aero lens 740 is placed in front of the display 730, driver air vent system 710, and the passenger air vent system 720. The aero lens 740 acts as the blending surface for both the driver air vent system 710 and the passenger air vent system 720.

The passenger air vent system 720 can be vertically smaller because it does not have to form vents around the instrument cluster 730, but rather only form vents around the aero lens 740. The control system can adjust the passenger air vent system 720 and the driver air vent system 710 separately.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments.

Although the disclosure and examples have been described with reference to the accompanying drawings, various changes and modifications will become apparent to those skilled in the art. Such changes and modifications are to be understood as being included within the scope of the disclosure. While certain embodiments have been described, these embodiments have been presented by way of example only and are not intended to limit the scope of the disclosure. The illustrative discussions above are not intended to be exhaustive or to limit the inventions to the precise forms described. Many modifications and variations are possible in view of the above teachings. Others skilled in the art are thereby enabled to best utilize the techniques and various embodiments with various modifications as suited to various uses. Any suitable combination of the elements and/or features of the various embodiments described above can be combined to provide further embodiments.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

in the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed air vent assembly. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other. Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application

What is claimed:

1. A thermal system for a vehicle, the thermal system comprising:
a blending surface;
at least one air source corresponding to a heating, ventilation and air conditioning (HVAC) unit disposed in the vehicle;
a first vent, including a first inlet and a first outlet, wherein the first inlet receives a first air jet from the at least one air source, wherein the first outlet produces therefrom a first plane of air, the first plane of air oriented in an acute angle relative a first horizontal plane;
a second vent, including a second inlet and a second outlet, wherein the second inlet receives a second air jet from the at least one air source wherein the second outlet produces therefrom a second plane of air, the second plane of air oriented in an obtuse angle relative a second horizontal plane;
wherein the first outlet and the second outlet are respectively configured to redirect the first plane of air and the second plane of air to intersect on or along a portion of the blending surface to form a combined air jet, wherein the combined air jet is directed into a cabin of the vehicle; and
a controller configured to adjust a target direction associated with the combined air jet based on control of at least one of the first air jet or the second air jet.

2. The thermal system of claim 1, wherein the controller is configured to adjust the target direction associated with the combined air jet including:
receive an indication to adjust the target direction at which the combined air jet is directed;
determine a first speed of the first air jet and a second speed of second air jet such that the first plane of air and the second plane of air intersect on or along the portion of the blending surface to form the combined air jet, the combined air jet directed at the target direction.

3. The thermal system of claim 2, wherein the indication to adjust the target direction is obtained from a user selection of a target location.

4. The thermal system of Claim I further comprising:
a first vent cover, wherein the first vent cover is configured to hide the first vent from sightlines of occupants of the vehicle; and
a second vent cover, wherein the second vent cover is configured to hide the second vent from sightlines of the occupants of the vehicle.

5. The thermal system of claim 1, wherein the blending surface is a display or a surface over a display.

6. The thermal system of claim 1, wherein the blending surface is flat.

7. The thermal system of claim 1, wherein the blending surface is concave.

8. The thermal system of claim 1, wherein the blending surface is convex.

9. The thermal system of claim 1, wherein the blending surface is a display on a front dash of the vehicle.

10. The thermal system of claim 1, wherein the at least one air source comprises an airway channel having a horizontal vane.

11. The thermal system of claim 10, wherein the airway channel further includes a first vertical vane and a second vertical vane.

12. The thermal system of claim 11, wherein the controller is further configured to:
adjust the first vertical vane and the horizontal vane to adjust a first speed and a first direction of the first air jet; and
adjust the second vertical vane and the horizontal vane to adjust a second speed and a second direction of the second air jet.

13. A thermal system for a vehicle, the thermal system comprising:
at least one air source corresponding to a heating, ventilation and air conditioning (HVAC) unit disposed in the vehicle;
a blending surface;
a first vent, including a first inlet and a first outlet, wherein the first inlet receives a first air jet from the at least one air source, wherein the first outlet produces therefrom a first plane of air, the first plane of air oriented in an acute angle relative a first horizontal plane;
a second vent, including a second inlet and a second outlet, wherein the second inlet receives a second air jet from the at least one air source wherein the second outlet produces therefrom a second plane of air, the second plane of air oriented in an obtuse angle relative a second horizontal plane, wherein the intersection of the first plane of air with the second plane of air forms a combined air jet directed toward a passenger compartment of the vehicle.

14. The thermal system of claim 13, further comprising a controller configured to adjust the target direction associated with the combined air jet, the controller configured to:
receive an indication to adjust the target direction at which the combined air jet is directed; and
determine a first speed of the first air jet and a second speed of second air jet such that the first plane of air and the second plane of air intersect on or along the portion of the blending surface to form the combined air jet, the combined air jet directed at the target direction.

15. The thermal system of claim 14, wherein the at least one air source includes a horizontal vane, a first vertical vane and a second vertical vane, wherein the horizontal vane, the first vertical vane, and the second vertical vane are configured to adjust the first speed of the first plane of air and the second speed of the second plane of air.

16. The thermal system of claim 15, wherein the controller is further configured to:
adjust the first vertical vane and the horizontal vane to adjust the first speed of the first plane of air; and
adjust the second vertical vane and the horizontal vane to adjust the second speed of the second plane of air.

17. The thermal system of claim 13, wherein the blending surface is a display or a surface over a display on a dash of the vehicle.

18. A thermal system for a vehicle, the thermal system comprising:
a first vent, including a first inlet and a first outlet, wherein the first inlet receives a first air jet from at least one air source, wherein the first outlet produces therefrom a first plane of air, the first plane of air oriented in an acute angle relative a first horizontal plane; and
a second vent, including a second inlet and a. second outlet, wherein the second inlet receives a. second air jet from the at least one air source wherein the second outlet produces therefrom a second plane of air, the second plane of air oriented in an obtuse angle relative a second horizontal plane,
wherein the intersection of the first plane of air with the second plane of air forms a combined air jet at a blending surface directed toward a passenger compartment of the vehicle.

19. The thermal system of claim 18, further comprising a controller configured to adjust a target direction associated with combined air jet based on control of at least one of the first air jet or the second air jet.

20. The thermal system of claim 18, wherein the at least one air source includes a horizontal vane, a first vertical vane and a second vertical vane, wherein the horizontal vane, the first vertical vane, and the second vertical vane are configured to adjust a first speed of the first plane of air and a second speed of the second plane of air.

21. The thermal system of claim 20, wherein the controller is further configured to:
adjust the first vertical vane and the horizontal vane to adjust the first speed of the first plane of air; and
adjust the second vertical vane and the horizontal vane to adjust the second speed of the second plane of air.

22. The thermal system of claim 18, wherein the blending surface is a display or a surface over a display on a dash of the vehicle.
